(19) United States
(12) Patent Application Publication
(10) Pub. No.: US 2019/0229511 A1
(43) Pub. Date: Jul. 25, 2019

(54) OVERHEAD ELECTRICAL INFEED

(71) Applicants: Norman R. Byrne, Ada, MI (US); Joseph D. Ward, Grand Rapids, MI (US); Shane Rogers, Rockford, MI (US); Beth L. Kolomyjec, Fenwick, MI (US)

(72) Inventors: Norman R. Byrne, Ada, MI (US); Joseph D. Ward, Grand Rapids, MI (US); Shane Rogers, Rockford, MI (US); Beth L. Kolomyjec, Fenwick, MI (US)

(21) Appl. No.: 16/253,001

(22) Filed: Jan. 21, 2019

Related U.S. Application Data
(60) Provisional application No. 62/619,233, filed on Jan. 19, 2018.
(60) Provisional application No. 62/683,615, filed on Jun. 11, 2018.

(51) Int. Cl. H02G 7/02; F21V 23/06

(52) U.S. Cl. CPC H02G 7/02; H01R 25/003; F21V 23/06

(57) ABSTRACT

An overhead electrical infeed system includes an overhead mount surface, an electrical cord coupled to the overhead mount surface, an electrical outlet housing coupled to a distal end portion of the cord having a proximal end portion mounted to the overhead mount surface and a distal end portion spaced from the proximal end portion. At least a portion of the weight of the electrical outlet housing is supported by the electrical cord. A retractor is positioned along the electrical cord and is operable to raise the electrical outlet housing or to retain the electrical outlet housing at a selected elevation. An electrical outlet is electrically energized by the electrical cord and is mounted to the electrical outlet housing, to provide users with access to electrical or data signals.

### CROSS REFERENCE TO RELATED APPLICATION

The present application hereby incorporates herein by reference in their entireties U.S. provisional application Ser. No. 62/619,233, filed Jan. 19, 2018 and Ser. No. 62/683,615, filed Jun. 11, 2018.

### FIELD OF THE INVENTION

The present invention relates to electrical outlets and wiring for work areas, living spaces, and the like.

### BACKGROUND OF THE INVENTION

Electrical infeeds are used to provide users with convenient access to electrical power, and typically include at least one electrical socket or connector that is compatible with electrical or electronic devices that are commonly used in a work area, living space, or the like.

### SUMMARY OF THE INVENTION

The present invention provides an overhead electrical infeed system for providing height-adjustable electrical or electronic data outlets to users in a work area, living space, or the like. The system includes an overhead mount, an electrical cord coupled to the overhead mount surface, and an electrical outlet housing coupled to a distal end portion of the cord having a proximal end portion mounted to the overhead mount surface and a distal end portion spaced from the proximal end portion. At least a portion of the weight of the electrical outlet housing is supported by the electrical cord. A retractor is positioned along the electrical cord and is operable to raise the electrical outlet housing or to retain the electrical outlet housing at a selected height or elevation. An electrical outlet at the outlet housing is electrically energized by the electrical cord and is mounted to the electrical outlet housing, to provide users with access to electrical or data signals.

In one form of the present invention, an overhead electrical infeed system includes an overhead mount, an electrical cord, an electrical outlet housing with at least one outlet, and a retractor. The electrical cord has a proximal end portion fixedly mounted to the overhead mount, a free distal end portion spaced from the proximal end portion, and an intermediate portion disposed between the proximal end portion and the free distal end portion. The intermediate cord portion is movably mounted to the overhead mount. The electrical outlet housing is coupled to the free distal end portion of the electrical cord. The retractor includes a counterweight and a cord-engaging member that is movably disposed along the intermediate portion of the electrical cord, below the overhead mount. The retractor serves to to raise the electrical outlet housing, or to retain the electrical outlet housing at a selected elevation below the overhead mount. The electrical outlet is electrically energized by the electrical cord, and is accessible from outside the housing and is adapted to convey electrical power to an electrical consumer.

The outlet housing or other portion (such as the retractor) of the overhead electrical infeed system can be easily grasped by a user and manually raised or lowered to thereby change the elevation of the electrical outlet(s) to a convenient location for the user. The weight of the outlet housing and outlet(s) are generally counterbalanced by the retractor, while friction elements may be disposed along the cord (such as friction bearings for pulleys) to help maintain a desired elevation for the outlet housing.

These and other objects, advantages, purposes and features of the present invention will become apparent upon review of the following specification in conjunction with the drawings.

### BRIEF DESCRIPTION OF THE DRAWINGS

FIG. 1 is a front perspective view of a first overhead electrical infeed device in accordance with the present invention;

FIG. 2 is a front perspective view of a second overhead electrical infeed device in accordance with the present invention;

FIG. 3 is a front perspective view of a third overhead electrical infeed device in accordance with the present invention;

FIG. 3A is a front perspective view of another overhead electrical infeed device that is similar to the overhead electrical infeed device of FIG. 3;

FIG. 4 is a front perspective view of a fourth overhead electrical infeed device in accordance with the present invention;

FIG. 5A is a front perspective view of a fifth overhead electrical infeed device in accordance with the present invention, shown in a retracted position;

FIG. 5B is another front perspective view the overhead electrical infeed device of FIG. 5A, shown in an extended position;

FIG. 6A is a front perspective view of a sixth overhead electrical infeed device in accordance with the present invention, shown in a retracted position;

FIG. 6B is another front perspective view the overhead electrical infeed device of FIG. 6A, shown in an extended position;

FIG. 7A is a front perspective view of a seventh overhead electrical infeed device in accordance with the present invention, shown in a retracted position;

FIG. 7B is another front perspective view the overhead electrical infeed device of FIG. 7A, shown in an extended position;

FIG. 8 is a series of front perspective views of four spool-type electrical infeed devices in accordance with the present invention;

FIG. 9 is a series of perspective views of a plurality of mounting plates and pulleys compatible for use with a subset of the overhead electrical infeed devices;

FIG. 10 is a series of perspective views of a plurality of different weights compatible for use with a subset of the overhead electrical infeed devices;

FIG. 11 is a series of perspective views of a plurality of electrical outlet housings compatible for use with the overhead electrical infeed devices;

FIG. 12 is a perspective view of a pair of enclosed coil-type electrical infeed devices in accordance with the present invention, shown in retracted and extended configurations;

FIG. 12A is a perspective view of a recessed above-the-ceiling coil-type electrical infeed device;

FIG. 12B is a perspective view of another enclosed coil-type electrical infeed device, shown in a recessed above-the-ceiling arrangement; and

FIG. 13 is a perspective view of a ceiling-suspended electrical infeed device with downwardly-directed lighting positioned over a work surface.

### DESCRIPTION OF THE PREFERRED EMBODIMENTS

Referring now to the drawings and the illustrative embodiments depicted therein, an overhead electrical infeed system 10 includes an overhead mount plate 12, an electrical cord or cable 14 for carrying electrical power and/or electronic data signals has a proximal end portion 14a fixed to mount plate 12 and a distal end portion 14b where an electrical power outlet housing 16 is attached, with an intermediate cord portion 14c disposed therebetween. In each of the embodiments described herein, an electrical power outlet housing 16 is vertically extendable and retractable relative to the corresponding mount plate, which may be attached to a ceiling surface, an overhead girder, or substantially any other overhead structure. The electrical outlet housings 16 may support one or more high voltage AC power outlets 18a, such as 110V or 220V AC outlets, and/or may support one or more low voltage DC power outlets 18b, such as 5V to 18V DC outlets (e.g., USB-style outlets). Where only high voltage AC power is supplied to a given electrical outlet housing 16, the high voltage AC power may be routed directly to any high voltage AC power outlets 18a, and through a DC power converter contained within housing 16 to supply the lower voltage DC power to any DC power outlets 18b. Although primarily described as an electrical power system, it will be appreciated that the principles of the present invention are equally applicable to electronic data systems having electronic signal receptacles and the like, and that the invention is not intended to be limited to systems for electrically powering other devices.

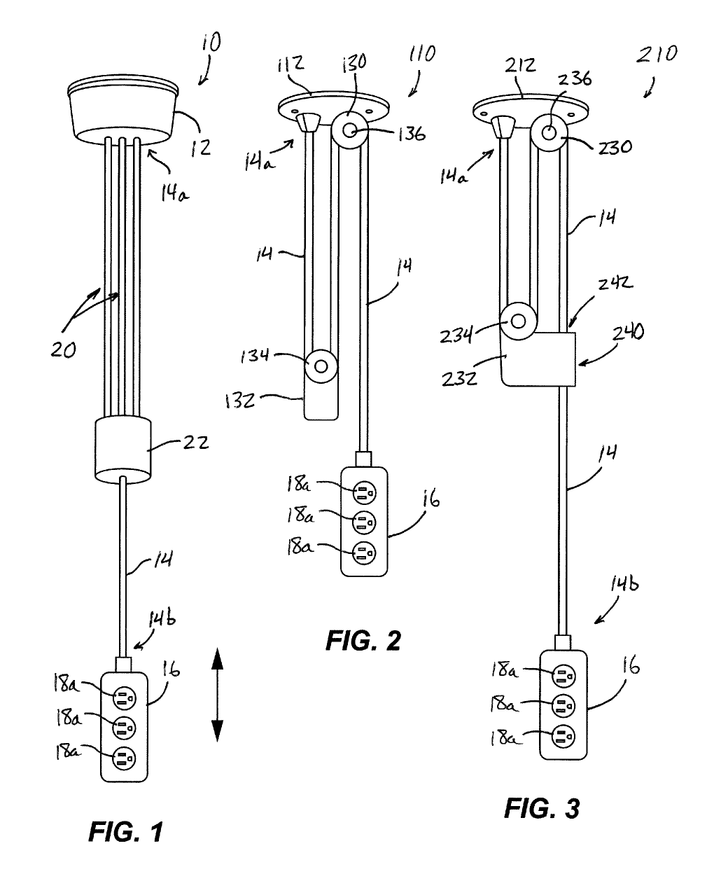

In the embodiment of FIG. 1, a pair of support cables 20 extend down from overhead mount plate 12, which is in the form of a generally cylindrical housing, to a retractor assembly 22. Power cord 14 may be wound onto a self-retracting spool contained in retractor assembly 22, so that a lower portion of cord 14 (including distal end portion 14b) is extendable and retractable relative to retractor assembly 22. In an alternative arrangement, retractor assembly 22 may house a simple pulley system in which support cables 20 are wound or routed in such a manner as to cause retractor assembly 22 to rise and fall relative to overhead mount plate 12, with electrical outlet housing 16 and distal end portion 14b of the power cord rising and falling with retractor assembly 22. A clock spring, electric winder, or similar mechanism may be used to provide lifting force for raising electrical outlet housing 16, and optionally for also raising retractor assembly 22.

Referring now to FIG. 2, another overhead electrical infeed system 110 includes an overhead mount plate 112 having proximal end portion 14a of power cord 14 fixed thereto, and with a pulley 130 also attached to overhead mount plate 112, spaced laterally from the cord proximal end portion 14a. A counterweight 132 is positioned along a section of power cord 14 between proximal end portion 14a and pulley 140, and has its own pulley 134 to facilitate rolling along power cord 14 as electrical outlet housing 16 is manually raised and lowered by a user. The weight of counterweight 132 is sufficient to balance the weight of electrical outlet housing 16 and electrical power outlets 18a, 18b, so that electrical outlet housing 16 will remain vertically fixed when not being manually moved. It will be appreciated that pulley 130 may be fitted with a frictional bearing 136 to resist rotation of its pulley wheel. This friction compensates for the changing amount of power cord 14 (and its weight) between electrical outlet housing 16 and pulley 130, so that as electrical outlet housing 16 is lowered and released, the added weight of cord 14 between housing 16 and pulley 130 will not cause the housing 16 to continue to drop. Thus, it will be appreciated that pulley 130 and counterweight 132 cooperate to act as a retractor for power cord 14 as electrical outlet housing 16 is manually raised by a user.

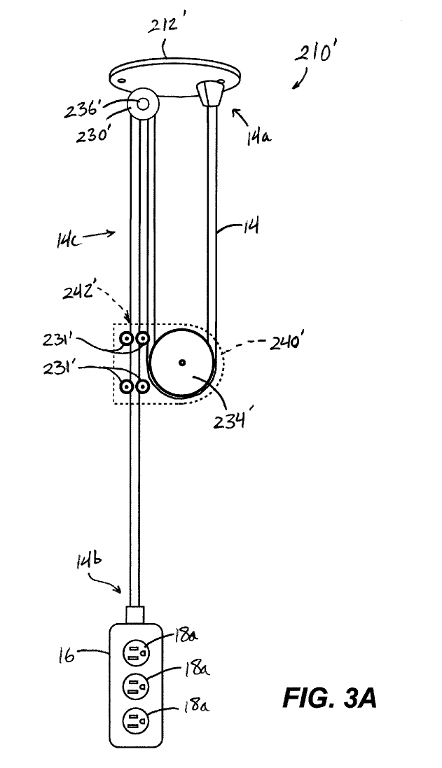

Optionally, a variation on the overhead electrical infeed system 110 is another overhead electrical infeed system 210 (FIG. 3) in which a counterweight 232 with its own counterweight pulley 234 has a laterally-extending counterweight housing portion 240 with a vertically-aligned guide channel or bore 242 through which passes a portion of power cord 14 located between electrical outlet housing 16 and a pulley 230 that is fixedly mounted to an overhead mount plate 212. Guide channel 242 permits power cord 14 to slide freely through counterweight housing portion 240 as electrical outlet housing 16 is raised and lowered, and serves to prevent entanglement or rubbing of respective cord portions, and to prevent entanglement or rubbing of cord portions with counterweight 232, as the outlet housing 16 is moved laterally and/or raised and lowered. Optionally, a clamping device (such as a lever-actuated or button-actuated clamping device) may be incorporated into counterweight housing portion 240 and operable to selectively impinge on power cord 14 inside of guide channel 242, to allow a user to selectively secure the vertical position of electrical outlet housing 16 until choosing to release the clamping device. Suitable clamping devices may include, for example, a cam-lever, a spring-biased peg or other extendable member, a V-shaped impinging element, or the like. In other respects overhead electrical infeed system 210 may be substantially similar or identical to system 110, described above, with like numerals used to designate components of system 210 that correspond to like components of system 110 with the addition of 100.

Another overhead electrical infeed system 210′ (FIG. 3A) provides a similar configuration as the infeed system 210. Infeed system 210′ includes an overhead pulley 230′ with bearing 236′ mounted to an overhead mount plate 212, and a counterweight 232′ that may be weighted portions of a counterweight housing portion 240′. A counterweight pulley 234′ is rotatably supported in housing portion 240 and has an intermediate cord portion 14c routed underneath, up to overhead pulley 230′, and back down through a vertically-aligned guide channel 242′ in the counterweight housing portion 240′. A plurality of counterweight pulleys 231′ are rotatably supported in the guide channel 242′ and are laterally spaced from the counterweight pulley 234′ to maintain a substantially fixed lateral spacing between the regions of intermediate cord portion 14c that are passing through the counterweight housing portion 240′.

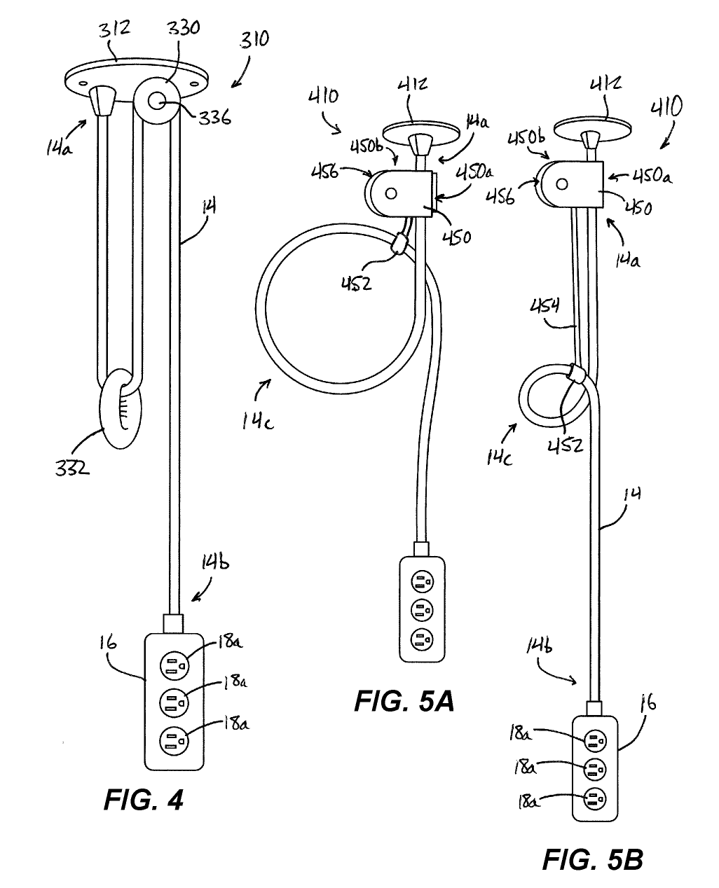

In a still further embodiment that is similar to overhead electrical infeed system 110, another electrical infeed system 310 is fitted with a generally ring-shaped or annular counterweight 332 (FIG. 4) that simply slides along a section of power cord 14 located between the power cord's proximal end portion 14a and a pulley 330 that is mounted to an overhead mount plate 312. Ring-shaped counterweight 332 may have polished radially-inwardly facing surfaces to limit or prevent abrading power cord 14. Ring-shaped counterweight 332 may be lower in cost to produce as compared to counterweights 132, 232, and may also be considered more aesthetically pleasing due to its simple shape and lack of a pulley or extraneous parts. In other respects overhead electrical infeed system 210 may be substantially similar or identical to system 110, described above, with like numerals used to designate components of system 310 that correspond to like components of system 110 with the addition of 200.

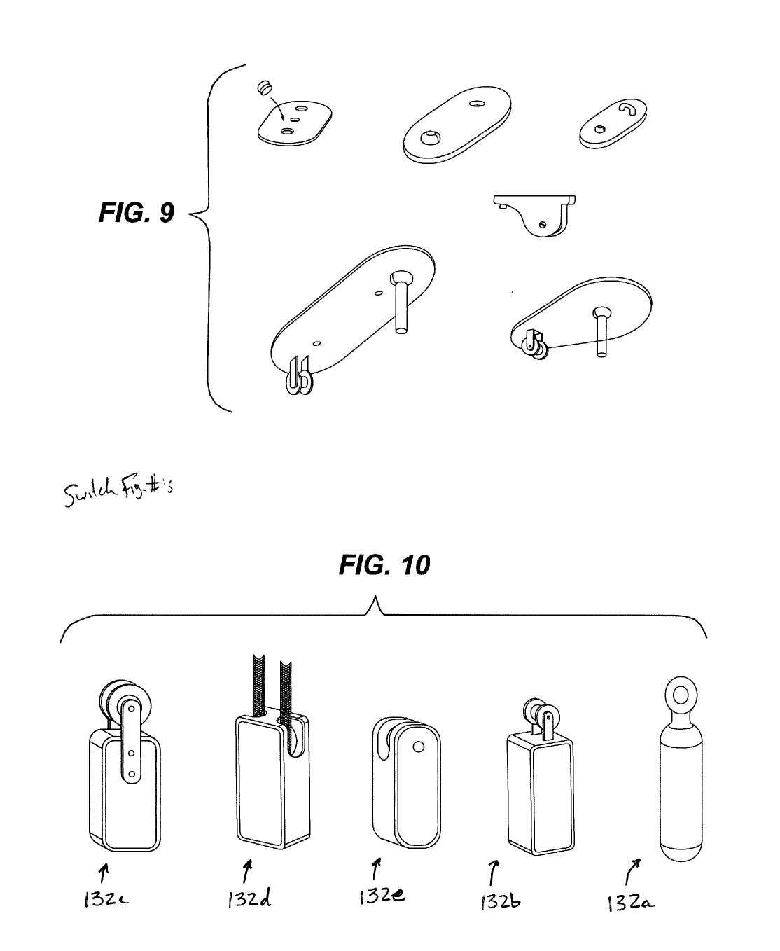

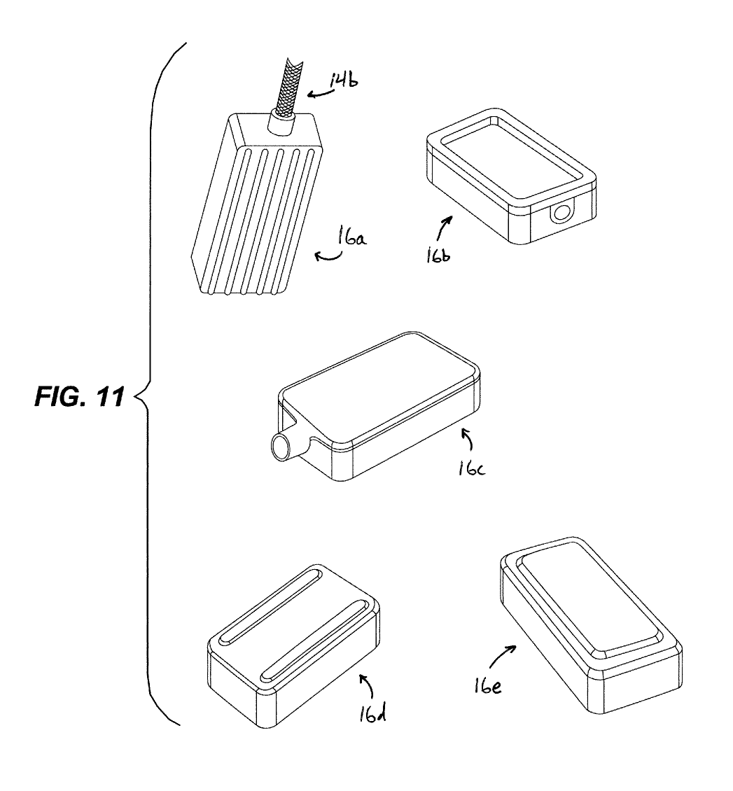

Various other types of counterweights are envisioned, such as shown in FIG. 9. For example, there are shown a first alternative counterweight 132a having an upper ring with polished inner surfaces and a lower weighted portion, a second alternative counterweight 132b having an upper pulley mounted to a lower weighted portion via a pair of brackets, a third alternative counterweight 132c having an upper pulley mounted to a lower weighted portion via a pair of integral brackets extending upwardly from an upper surface of the lower weighted portion, a fourth alternative counterweight 132d having an integral pulley contained in an upper end portion of a weight, and a fifth alternative counterweight 132e that is substantially identical to the fourth alternative counterweight 132d except for fifth alternative counterweight 132e having a rounded bottom end. Moreover, various other shapes and configurations of overhead mount plates and ceiling-mounted or plate-mounted pulleys are envisioned, such as shown in FIG. 10. In addition, various shapes and configurations of power outlet housings 16a-e are envisioned, such as shown in FIG. 11.

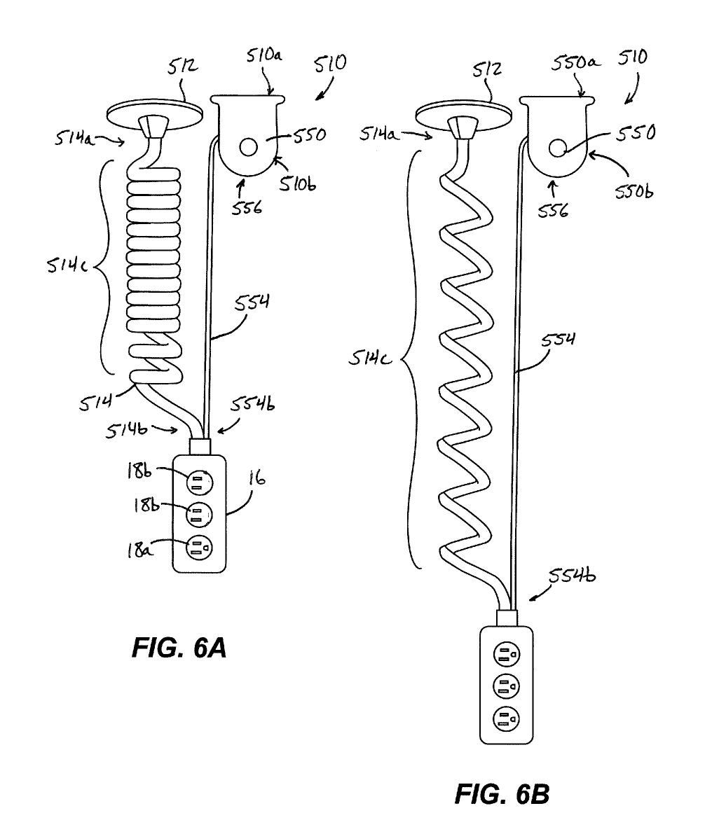

It is further envisioned that spring-loaded pulleys may be used to provide vertical adjustment for an overhead-mounted electrical outlet housing. For example, in FIGS. 5A-6B there are shown two implementations of spring-loaded pulleys. In FIGS. 5A and 5B there is shown an electrical infeed system 410 in which power cord 14 is supported by an overhead mount plate 412 and has a retractor 450 having a clamping side 450a secured to proximal end portion 14a of power cord 14 just below mount plate 412. A power cord loop 14c is formed in a central region of power cord 14, between proximal end portion 14a and distal end portion 14b. A cord clamp or gripper 452 is secured to power cord 14 near an end of power cord loop 14c that is closer to distal end portion 14b. A retractor cord 454 is wound around a pulley or winding spool 456 that is disposed in a retractor side 450b of the retractor 450, and has a distal end 454b attached to the cord clamp or gripper 452. Retractor 450 contains a clock spring or other biasing member that winds retractor cord 454 onto the winding spool 456, thus drawing electrical outlet housing 16 upwardly to a raised or retracted position such as shown in FIG. 5A. A ratcheting device, centrifugal clutch, or similar mechanism may be incorporated into retractor 450 to selectively limit or cancel the upward biasing force when electrical outlet housing 16 is at a lowered position (FIG. 5B), so that electrical outlet housing 16 will remain at that lowered position until a user manually raises the outlet housing 16 or gives an initial downward pull on the outlet housing to release the mechanism and permit retractor cord 454 to be wound onto the winding spool 456 as the outlet housing and distal end portion 14b of the power cord are raised. In other respects, overhead electrical infeed system 410 may be substantially similar or identical to system 110, described above, with like numerals used to designate components of system 410 that correspond to like components of system 110 with the addition of 300.

Another electrical infeed system 510 (FIGS. 6A and 6B) is similar in some respects to electrical infeed system 410 of FIGS. 5A and 5B, including a retractor 550 with a retractor cord 554 wound around a pulley or winding spool 556 that is disposed in a retractor or spool side 550b. However, the retractor 550 of electrical infeed system 510 has a securing side 550a that is configured to mount to a surface such as a ceiling surface or other overhead support, which may be the same surface to which an overhead mount plate 512 is attached. A distal end portion 554b of retractor cord 554 is attached directly to electrical power outlet housing 16, and rather than forming a loop in the power cord as in the system 410 of FIGS. 5A and 5B), system 510 includes a power cord 514 having a spring-like resilient middle cord section 514c disposed between a proximal end portion 514a attached to overhead mount plate 512 and a distal end portion 514b attached to electrical power outlet housing 16.

As outlet housing 16 is manually grasped and lowered by a user, retractor cord 554 is payed out from retractor 550 as it unwinds from winding spool 556, against the biasing force applied to the spool by a biasing mechanism in retractor 550. The resilient middle cord section 514c expands like a coil spring as outlet housing 16 is lowered, such as shown in FIG. 6B. When outlet housing 16 is raised, the resilience of middle cord section 514c caused it to retract again toward the more compact configuration of FIG. 5A, as retractor cord 554 is wound back onto winding spool 556. It will be appreciated that resilient middle cord section 514c does not have enough resilient biasing force to raise outlet housing 16 from the lowered position of FIG. 5B, such that retractor cord 554 remains in tension and supports a portion of the weight of the outlet housing 16 when the outlet housing is in its lowered position. The additional biasing force provided by retractor 550 is needed to lift outlet housing 16 from its lowered position.

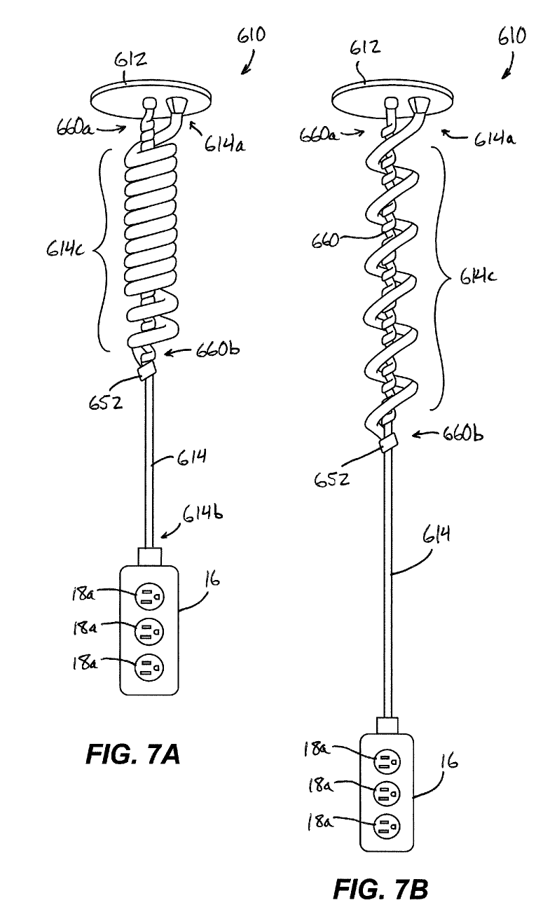

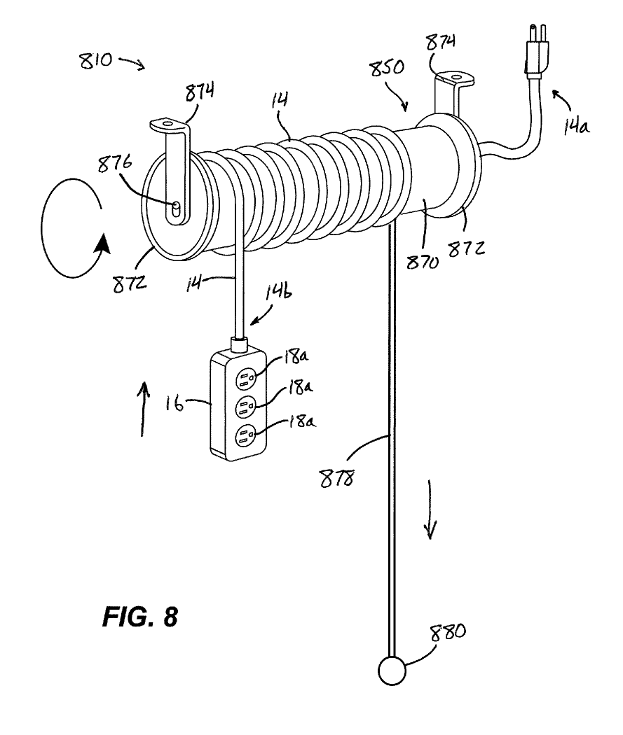

In another arrangement an electrical infeed system 610 (FIGS. 7A and 7B) is similar in some respects to both the electrical infeed system 410 of FIGS. 5A and 5B, and the electrical infeed system 510 of FIGS. 6A and 6B. In the case of electrical infeed system 610, however, there is no winding retractor or pulley, and instead a coil “helper spring” or resilient cord 660 is provided to facilitate raising power outlet housing 16, and there is no mechanism provided to retain power outlet housing 16 in the lowered position of FIG. 7B. An electrical power cord 614 includes a resilient middle cord section 614c disposed between an upper or proximal end portion 614a and a lower or distal end portion 614b. The coil helper spring or resilient cord 660 has a proximal end portion 660a attached to an overhead mount plate 612 and a distal end portion 660b attached to power cord 614 at a lower end of the resilient cord section 614c via a cord clamp or gripper 652. Electrical power cord 614 has its proximal end portion 614a attached to overhead mount plate 612, and its distal end portion 614b coupled directly to power outlet housing 16. Coil helper spring or resilient cord 660 extends centrally through the coiled resilient cord section 614, as best shown in FIG. 7B, and may be substantially obscured from view by the coiled resilient cord section 614 when power outlet housing 16 is raised (FIG. 7A). Because no mechanism is provided to retain power outlet housing 16 in the lowered position of FIG. 7B, power outlet housing 16 may be free to raise and lower during use, according to the amount of downward force applied to electrical cords and devices plugged into its one or more electrical outlets 18a, 18b.

Referring now to FIG. 8, a spool-type overhead electrical infeed system 810 includes an exposed manually-wound retractor assembly 850 includes a spool 870 with enlarged-diameter end flanges 872, and L-brackets 874 mounted at the opposite ends of a spindle or axle 876 that extends through a central axis of spool 870. Proximal end portion 14a of power cord 14 is fitted with a conventional 110V AC plug for engaging an electrical power source, such as a conventional ceiling-mounted power outlet. A biasing winding force may be selectively applied to spool 870, in the direction of a curved arrow in FIG. 8, by a user pulling downwardly on a winding cord 878 that is drawn off of spool 870 on an opposite side from where the electrical outlet housing 16 and outlets 18a are suspended by the distal end portion 14b of the cord 14. A knob 880 or other grasping feature may be provided to facilitate gripping by a user for raising or lowering the winding cord 878. Optionally, spool 870 incorporates a friction feature, ratcheting feature, spring-biasing element, or the like, which allows the spool 870 to be stopped at different elevations of the outlet housing 16. Optionally, winding cord 878 and/or knob 880 may be weighted to counterbalance the outlet housing 16 and portion of the cord 14 that extends between the outlet housing 16 and the spool 870.

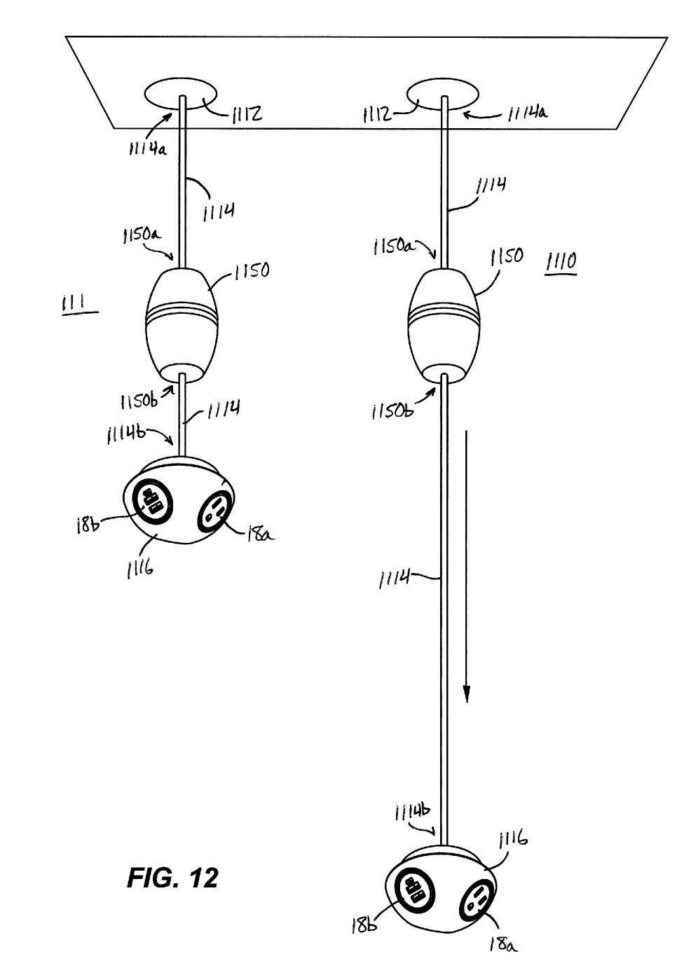

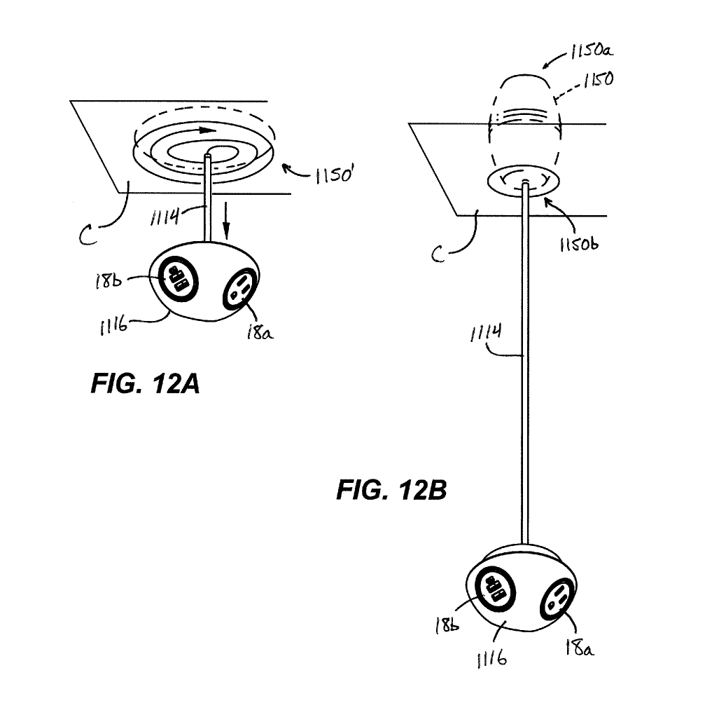

In another arrangement an electrical infeed system 1110 (FIG. 12) includes an electrical cord or cable 1114 for carrying electrical power and/or electronic data signals has a proximal end portion 1114a fixed to mount plate 1112 and a distal end portion 14b where an electrical power outlet housing 1116 is attached. In the embodiments shown at upper-left, center, and right of FIG. 12, a retractor assembly 1150 contains a coiled or spooled section of cable 1114, which permits a user to pull down on the outlet housing 1116 and extend (or release to shorten) the distance between the power outlet housing 1116 and the mount plate 1112 or associated ceiling surface. Optionally, and as shown in FIG. 12B, the retractor assembly 1150 may be recessed above a ceiling surface C, in which case the retractor assembly 1150 may be retained in a fixed position above the ceiling surface C. However, it is further envisioned that the retractor assembly 1150 can be configured so that the electrical cord or cable 1114 may be payed out and retracted into both the top end 1150a and bottom end 1150b of the retractor assembly 1150. Referring to FIG. 12A, a ceiling-concealed retractor 1150′ is shown to be recessed and hidden above the ceiling surface C, so that only a portion of electrical cord or cable 1114 is visible entering the ceiling surface C from below, and retraction and extension of cable 1114 above ceiling surface C.

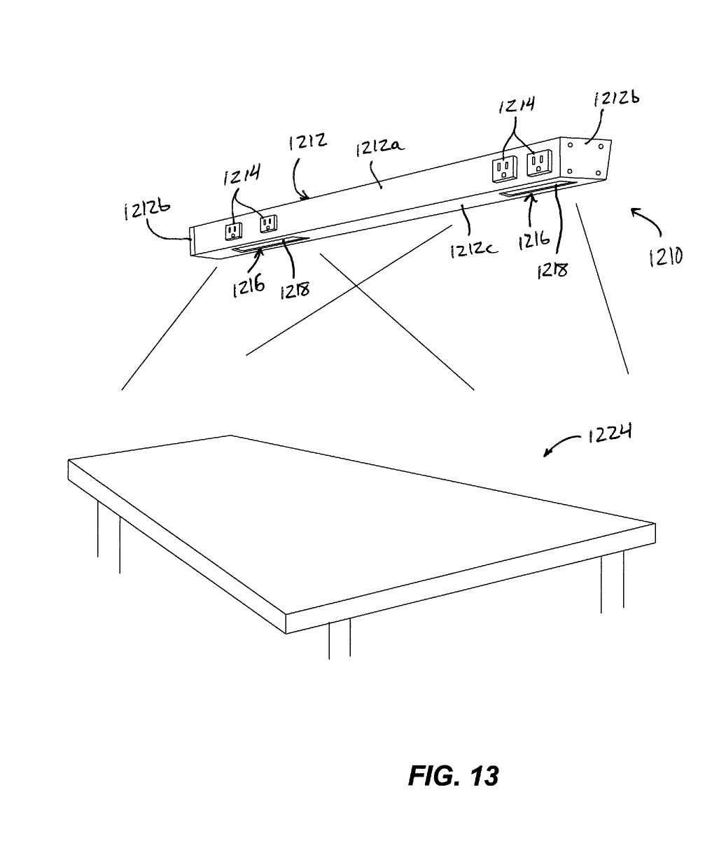

Optionally, lighting capability may be provided in an electrical infeed system 1210, such as shown in FIG. 13. Electrical infeed system includes an elongated housing 1212 supporting a plurality of electrical outlets 1214 along one or more sides 1212a of the housing 1212. A pair of removable end caps 1212b provide access to an interior of the housing 1212, where wiring, electrical lighting 1216, and portions of the outlets 1214 are located. Lighting 1216 shines downwardly through a slot or opening 1218 in a lower panel 1212c of the housing 1212, which slot or opening 1218 may optionally be fitted with a lens. An electrical power cord 1220 extends downwardly and enters housing 1212 to supply electrical energy to the outlets 1214 and the lighting 1216. A set of suspension cords extend downwardly from the ceiling and attach to the housing 1212 to support the infeed system 1210 over a work surface 1224. Optionally, pulleys are provided for mounting the cords to the ceiling, to provide height-adjustability for the electrical infeed system 1210.

Thus, the overhead electrical infeed systems of the present invention provide various arrangements and mechanisms for providing convenient overhead access to electrical power for users of a work area, living space, or substantially any enclosed or partially-enclosed area having overhead support structure capable of supporting electrical wiring. Various embodiments may permit a power outlet housing of the system to be retained at a desired lowered position for convenience access by a user, and use different mechanism for raising the power outlet housing. Thus, users with portable electrical devices such as tools or appliances, or portable electronic devices such as mobile phones and computers, may be provided with convenient access to electrical power at overhead locations.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. An overhead electrical infeed system comprising:
an overhead mount;
an electrical cord having a proximal end portion fixedly mounted to said overhead mount, a free distal end portion spaced from said proximal end portion, and an intermediate portion disposed between said proximal end portion and said free distal end portion and movably mounted to said overhead mount;
an electrical outlet housing coupled to said free distal end portion of said electrical cord;
a retractor comprising a counterweight and a cord-engaging member movably disposed along said intermediate portion of said electrical cord and operable to raise said electrical outlet housing or to retain said electrical outlet housing at a selected elevation below said overhead mount; and
an electrical outlet supported at said electrical outlet housing and configured to be electrically energized by said electrical cord, wherein said electrical outlet is accessible from outside said housing and is adapted to convey electrical power to an electrical consumer.

2. The overhead electrical infeed system of claim 1, wherein said cord-engaging member comprises a counterweight pulley.

3. The overhead electrical infeed system of claim 2, wherein said counterweight pulley comprises a friction bearing configured to resist movement of said electrical cord and to maintain said electrical outlet housing in a plurality of different selected elevations relative to said overhead mount.

4. The overhead electrical infeed system of claim 2, wherein said retractor comprises a retractor housing disposed around said electrical cord, and wherein said electrical cord is vertically movable through said retractor housing in response to vertical movement of said electrical outlet housing relative to said overhead mount.

5. The overhead electrical infeed system of claim 4, further comprising a plurality of guide pulleys rotatably mounted in said retractor housing along opposite sides of said electrical cord, wherein said guide pulleys are configured to maintain a fixed lateral spacing between said electrical cord and said counterweight pulley.

6. The overhead electrical infeed system of claim 4, wherein said counterweight is disposed inside of said housing.

7. The overhead electrical infeed system of claim 4, wherein said counterweight pulley is disposed inside of said housing.

8. The overhead electrical infeed system of claim 7, wherein said counterweight is disposed inside of said housing.

9. The overhead electrical infeed system of claim 1, further comprising an overhead pulley rotatably coupled to said overhead mount, wherein said intermediate portion of said cord is routed over said overhead pulley.

10. The overhead electrical infeed system of claim 9, wherein said overhead pulley comprises a friction bearing configured to resist movement of said electrical cord and to maintain said electrical outlet housing in a plurality of different selected elevations relative to said overhead mount.

11. The overhead electrical infeed system of claim 1, wherein said electrical outlet comprises at least one chosen from a high voltage AC power outlet, a low voltage DC power outlet, and an electronic data outlet.

12. An overhead electrical infeed system comprising:
an overhead mount;
an overhead pulley rotatably coupled to said overhead mount;
an electrical cord having a proximal end portion fixedly mounted to said overhead mount, a free distal end portion spaced from said proximal end portion, and an intermediate portion disposed between said proximal end portion and said free distal end portion and movably mounted to said overhead pulley;
an electrical outlet housing coupled to said free distal end portion of said electrical cord;
a retractor comprising a counterweight and a cord-engaging member movably disposed along said intermediate portion of said electrical cord and operable to raise said electrical outlet housing or to retain said electrical outlet housing at a selected elevation below said overhead mount;
a retractor housing coupled to said retractor and disposed around said electrical cord, wherein said electrical cord is vertically movable through said retractor housing in response to vertical movement of said electrical outlet housing relative to said overhead mount, wherein said retractor housing is configured to maintain a fixed lateral spacing between said electrical cord and said counterweight pulley; and
an electrical outlet supported at said electrical outlet housing and configured to be electrically energized by said electrical cord, wherein said electrical outlet is accessible from outside said housing and is adapted to convey electrical power to an electrical consumer.

13. The overhead electrical infeed system of claim 12, wherein at least one of said overhead pulley and said retractor comprises a frictional element configured to resist movement of said electrical cord and to maintain said electrical outlet housing in a plurality of different selected elevations relative to said overhead mount.

14. The overhead electrical infeed system of claim 13, wherein said frictional element comprises a friction bearing.
